(19) United States
(12) Patent Application Publication
(10) Pub. No.: US 2012/0067217 A1
(43) Pub. Date: Mar. 22, 2012

(54) OXYGEN-ABSORBING MULTILAYER FILM, PACKAGING MATERIAL COMPRISING THE SAME, AND PACKAGING CONTAINER

(76) Inventor: Shizuo KITAHARA, Tokyo (JP)

(21) Appl. No.: 13/308,245

(22) Filed: Nov. 30, 2011

Related U.S. Application Data
(62) Division of application No. 11/794,155, filed on Jun. 26, 2007.

(30) Foreign Application Priority Data
Dec. 27, 2004 (JP) 2004-375807

(51) Int. Cl. B01D 53/04; B65B 7/00

(52) U.S. Cl. 95/138; 53/476

(57) ABSTRACT

[Problem]

To provide an oxygen-absorbing multilayer film which exhibits high oxygen-absorbability without the addition of a transition metal salt usually added as a catalyst for the purpose of enhancing oxygen-absorbability and which does not cause a problem of odors even after absorbing oxygen, a packaging material comprising the multilayer film, and a packaging container obtained by molding this packaging material.

[Means for Dissolution]

An oxygen-absorbing multilayer film having a thickness of less than 250 μm that comprises a gas barrier material layer, an oxygen-absorbent layer and a sealing material layer laminated in this order, wherein an oxygen-absorbent constituting the subject oxygen-absorbent layer comprises a cyclized product of a conjugated diene polymer as the major component. There are also disclosed a packaging material comprising this multilayer film and a packaging container obtained by molding this packaging material.

This application is a Divisional of copending application Ser. No. 11/794,155 filed on Jun. 26, 2007, which is a 371 national phase application of PCT/JP2005/023562 filed Dec. 22, 2005, which claims priority to Application No. 2004-375807 filed in Japan, on Dec. 27, 2004. The entire contents of all of the above applications are hereby incorporated by reference.

### TECHNICAL FIELD

The present invention relates to an oxygen-absorbing multilayer film used for packaging for the purpose of preventing deterioration in quality of foodstuffs, drugs and the like due to oxygen, a packaging material comprising this multilayer film, and a packaging container obtained by molding this packaging material; and in more detail, to an oxygen-absorbing multilayer film which exhibits excellent oxygen-absorbability, has a low content of metals, and is transparent and highly safe, a packaging material comprising this multilayer film, and a packaging container obtained by molding this packaging material.

### BACKGROUND ART

Metals, glass, various plastics, and the like have hitherto been used as a material for foodstuff-packaging containers. In recent years, plastic containers have been frequently used as a packaging container for various foodstuffs from the viewpoints of their lightweightness, easiness of shape designing, impact resistance, costs, and the like.

When oxygen permeates into a foodstuff-packaging container from the outside, the contents (foodstuff) suffer from changes in qualities and deterioration causing lowering of its flavor or freshness. In order to avoid such a state of things, a foodstuff-packaging container is required of performances for preventing the permeation of oxygen or the like from the outside. Although practically no gases permeate from the outside in the case of metal cans or glass bottles, plastics allow a non-negligible amount of gases to permeate them. Then, in order to prevent the permeation of gases from the outside, the plastic packaging material is usually caused to have a multilayer structure. Components, compositions and the like of metallic foils, resins, etc. constituting the respective layers have been extensively studied.

On the other hand, it is also necessary to prevent changes in qualities and deterioration due to oxygen within the packaging container, and the inside is evacuated or filled with an inert gas. However, such a method gives only insufficient effects, and an oxygen-absorbing substance is charged in the packaging container.

As the substance charged in the packaging container, an iron powder is representative. An oxygen-absorbent comprising an iron powder as the major component is accommodated in a pouch, and this pouch is enclosed in the foodstuff-packaging container. The iron powder has advantages that it is inexpensive and that its oxygen absorption rate is large. On the other hand, it involves some problems. That is, in the case of utilizing a metal detector for the purpose of detecting a foreign substance after packaging foodstuff, the judgment of the presence of a foreign substance is difficult. Besides, a packaging material having the contents charged therein cannot be treated in a microwave oven as it is. Also, a problem that an infant or an aged person eats this by mistake is pointed out. Furthermore, there is a problem that an oxygen absorption performance is reduced in a dry atmosphere.

Recently, methods such as incorporation of a compound having oxygen-absorbability with a resin for packaging materials or impartation of oxygen-absorbability to a resin for packaging materials per se are reported. When a resin having oxygen-absorbability is used as a packaging material, it not only absorbs oxygen on the inside of the packaging container, but also exhibits a function to prevent the permeation of oxygen from the outside of the packaging container.

For example, Patent Document 1 discloses a composition comprising a polymer of an ethylenically unsaturated hydrocarbon having a specific amount of a carbon-carbon double bond such as polypentenamer, 1,2-polybutadiene or trans-polyisoprene and a transition metal catalyst such as 2-ethylhexanoic acid salts or neodecanoic acid salts of manganese, cobalt, etc.

Patent Document 2 discloses an oxygen-scavenging composition comprising a polyterpene such as poly(α-pinene), poly(β-pinene) or poly(dipentene) and a transition metal salt such as cobalt oleate or cobalt neodecanoate.

Patent Document 3 describes that an oxygen scavenger constituted of an ethylenically unsaturated hydrocarbon such as 1,2-polybutadiene, 1,4-polybutadiene, a styrene-butadiene copolymer or a styrene-isoprene copolymer and a stearic acid salt, a neodecanoic acid salt or the like of a transition metal such as cobalt or manganese is admixed with a thermoplastic polymer.

Furthermore, Patent Document 4 discloses that a composition comprising a copolymer of ethylene with a cyclic alkylene (preferably cyclopentene) and a transition metal catalyst is blended in a semi-crystalline polymer such as polyethylene. As the transition metal catalyst, 2-ethylhexanoic acid salts, oleic acid salts, neodecanoic acid salts or the like of cobalt, manganese, iron, nickel, copper or the like are described.

However, the respective compositions disclosed in these patent documents involve problems that the oxygen absorption performance is not sufficient and that a peculiar odor assumed to be due to by-products of oxygen-trapping reactions remains in a packaging container. Further, because these compositions contain the transition metal, the polymer is liable to be deteriorated with the progress of the oxygen absorption reaction, whereby a mechanical strength of the packaging material is remarkably reduced or the transition metal salt elutes, and therefore it is difficult to use them in some applications.
Patent Document 1: JP-T-08-502306 (WO 94/07944)
Patent Document 2: JP-T-2001-507045 (WO 98/06799)
Patent Document 3: JP-A-2003-071992
Patent Document 4: JP-T-2003-504042 (WO 01/03521)

### DISCLOSURE OF THE INVENTION

### Problems that the Invention is to Solve

Accordingly, an object of the invention is to provide an oxygen-absorbing multilayer film used for the purpose of preventing deterioration in qualities of foodstuffs, drugs and the like due to oxygen, which exhibits excellent oxygen-absorbability without incorporating a salt of a transition metal such as cobalt or the like and does not cause odor problems. Another object of the invention is to provide a packaging material comprising the foregoing oxygen-absorbing multilayer film. A still another object of the invention is to provide a packaging container obtained by molding this packaging material.

### Means for Solving the Problems

In order to solve the foregoing problems, the present inventor made extensive and intensive investigations, found that, in a multilayer film comprising a gas barrier material layer, an oxygen-absorbent layer and a sealing material layer, use of a polymer having a specified structure as a material for constituting the oxygen-absorbent layer is effective, and has accomplished the invention on the basis of this knowledge.

Thus, according to the invention, there is provided an oxygen-absorbing multilayer film having a thickness of less than 250 μm that comprises a gas barrier material layer, an oxygen-absorbent layer and a sealing material layer laminated in this order, wherein an oxygen-absorbent constituting the subject oxygen-absorbent layer comprises a cyclized product of a conjugated diene polymer as the major component.

Also, according to the invention, there is provided a packaging material comprising the foregoing oxygen-absorbing multilayer film.

Furthermore, according to the invention, there is provided a packaging container obtained by molding the foregoing packaging material.

### Advantages of the Invention

The oxygen-absorbing multilayer film of the invention exhibits excellent oxygen-absorbability and does not cause a problem of a residual odor. Since the use of a transition metal is not essential, the oxygen-absorbing multilayer film of the invention is highly safe, does not bring about a problem on metal detection or in use in a microwave oven, etc. and is free from a risk of lowering of strengths or the like of packaging materials caused by deterioration.

The oxygen-absorbing multilayer film of the invention is suitable as a packaging material of various foodstuffs, chemicals, drugs, cosmetics, and the like.

### BEST MODES FOR CARRYING OUT THE INVENTION

The oxygen-absorbing multilayer film of the invention is a multilayer film having a thickness of less than 250 μm, where a gas barrier material layer, an oxygen-absorbent layer and a sealing material layer are laminated in this order.

The gas barrier material layer is a layer provided for the purpose of hindering the permeation of a gas from the outside. When a bag-like packaging material, for example, is constituted using the oxygen-absorbing multilayer film, the gas barrier material layer acts as an external layer. Oxygen permeability of the gas barrier material layer is preferably small as far as possible so far as processability and costs allow. The oxygen permeability is required to be not more than 100 cc/m²·atm·day (at 25° C. and 65% RH), and more preferably not more than 50 cc/m²·atm·day (at 25° C. and 65% RH) regardless of its thickness.

The material for constituting the gas barrier material layer is not particularly limited so far as it does not permit a gas such as oxygen and water vapor to permeate it, and metals, inorganic materials, resins, and the like are useful.

As the metal, aluminum having low gas permeability is generally used. Metals may be laminated as a foil on a resin film or the like, or a thin film may be formed on a resin film or the like by means of vapor deposition.

As the inorganic material, a metal oxide such as silica or alumina is useful. The metal oxide is vapor-deposited on a resin film or the like singly or in combination.

Though resins are inferior to metals and inorganic materials with respect to gas barrier properties, they allow various choices not only in mechanical properties, thermal properties, chemical resistance and optical properties but also in manufacturing methods and are preferably used as a gas barrier material from the standpoint of these advantages. The resin used for the gas barrier material layer of the invention is not particularly limited, and all of resins having good gas barrier properties can be used. Use of a chlorine-free resin is preferable because noxious gases are not generated on incineration disposal.

Of these, a transparent vapor-deposited film obtained by vapor deposition of an inorganic oxide on a resin film is preferable for use.

Concrete examples of the resin used for the gas barrier material layer include polyvinyl alcohol resins such as polyvinyl alcohol or an ethylene/vinyl alcohol copolymer; polyester resins such as polyethylene terephthalate or polybutylene terephthalate; polyamide resins such as nylon 6, nylon 66, nylon 610, nylon 11, nylon 12, MXD nylon (poly-m-xylylene adipamide), or copolymers thereof; poly-aramid resins; polycarbonate resins; polystyrene resins; polyacetal resins; fluororesins; thermoplastic polyurethanes such as polyether-based, adipate ester-based, caprolactone ester-based, or polycarbonate-based one; vinyl halide resins such as polyvinylidene chloride or polyvinyl chloride; and polyacrylonitrile. An inorganic oxide such as aluminum oxide or silicon oxide can be vapor-deposited on such a gas barrier material layer.

These resins can be properly chosen depending upon the purpose of a multilayer film taking into consideration required properties such as gas barrier properties, mechanical properties including strength, toughness and rigidity, heat resistance, printability, transparency, or adhesiveness. These resins may be used singly as one kind or in combination of two or more kinds thereof.

The resin used as the gas barrier material layer can also be blended with a heat stabilizer; an ultraviolet ray absorbent; an antioxidant; a coloring agent; a pigment; a neutralizing agent; a plasticizer such as phthalic esters and glycol esters; a filler; a surfactant; a leveling agent; a light stabilizer; a dehydrating agent such as alkaline earth metal oxides; a deodorant such as activated carbon or zeolite; a tackifier (for example, castor oil derivatives, sorbitan higher fatty acid esters, and low-molecular weight polybutene); a pot life extender (for example, acetylacetone, methanol, and methyl orthoacetate); a cissing improving agent; other resins (for example, poly-α-olefins); or the like.

Also, an anti-blocking agent, an anti-fogging agent, a heat resistant stabilizer, a weather resistant stabilizer, a lubricant, an antistatic agent, a reinforcing agent, a flame retardant, a coupling agent, a blowing agent, a mold releasing agent, or the like can be added, if desired.

For the purpose of imparting heat resistance or the like, a protective layer can be formed on the outside of the gas barrier material layer.

Examples of a resin used for the protective layer include ethylene polymers such as high-density polyethylene; propylene polymers such as a propylene homopolymer, a propylene/ethylene random copolymer, or a propylene/ethylene block copolymer; polyamides such as nylon 6 or nylon 66; and polyesters such as polyethylene terephthalate. Of these, polyamides and polyesters are preferable.

In the case where a polyester film, a polyamide film, an organic oxide-vapor deposited film, a polyvinylidene chloride-coated film, or the like is used as the gas barrier material layer, such a gas barrier material layer also functions as a protective layer at the same time.

The oxygen-absorbent layer of the oxygen-absorbing multilayer film of the invention absorbs oxygen that permeates the gas barrier material layer from the outside. When a bag-like packaging container, for example, is constituted by using a packaging material comprising an oxygen-absorbing multilayer film, the oxygen-absorbent layer acts as a layer having a function to absorb oxygen on the inside of the packaging container via an oxygen-permeating layer (sealing material layer).

The foregoing oxygen-absorbent layer is constituted of an oxygen-absorbent comprising a cyclized product of a conjugated diene polymer as the major component. The content of the cyclized product of a conjugated diene polymer in the oxygen-absorbent is 50% by weight or more, preferably 60% by weight or more, and more preferably 70% by weight or more. Too low a content of the cyclized product of a conjugated diene polymer is unpreferable, because it causes reduction in oxygen-absorbability.

In the oxygen-absorbing multilayer film of the invention, the oxygen-absorbent layer may contain a known oxygen-absorbing component other than the cyclized product of a conjugated diene polymer so far as the effects of the invention are not hindered. The amount of the oxygen-absorbing component other than the cyclized product of a conjugated diene polymer is less than 50% by weight, preferably less than 40% by weight, and more preferably less than 30% by weight relative to the whole amount of the oxygen-absorbing components (the total amount of the cyclized product of a conjugated diene polymer and the oxygen-absorbing component other than the cyclized product of a conjugated diene polymer).

In the oxygen-absorbing multilayer film of the invention, the oxygen-absorbent layer may contain a resin component other than the oxygen-absorbing component. Concrete examples of such a resin component include polyolefin resins such as polypropylene or polyethylene.

The cyclized product of a conjugated diene polymer used in the invention is one obtained by a cyclization reaction of a conjugated diene polymer in the presence of an acid catalyst.

As the conjugated diene polymer, homopolymers and copolymers of a conjugated diene monomer and copolymers of a conjugated diene monomer and a monomer copolymerizable therewith can be used.

The conjugated diene monomer is not particularly limited, and concrete examples thereof include 1,3-butadiene, isoprene, 2,3-dimethyl-1,3-butadiene, 2-phenyl-1,3-butadiene, 1,3-pentadiene, 2-methyl-1,3-pentadiene, 1,3-hexadiene, 4,5-diethyl-1,3-octadiene, and 3-butyl-1,3-octadiene. These monomers may be used singly or in combination of two or more kinds thereof.

Examples of other monomers copolymerizable with the conjugated diene monomer include aromatic vinyl monomers such as styrene, o-methylstyrene, p-methylstyrene, m-methylstyrene, 2,4-dimethylstyrene, ethylstyrene, p-t-butylstyrene, α-methylstyrene, α-methyl-p-methylstyrene, o-chlorostyrene, m-chlorostyrene, p-chlorostyrene, p-bromostyrene, 2,4-dibromostyrene, or vinylnaphthalene; linear olefin monomers such as ethylene, propylene, or 1-butene; cyclic olefin monomers such as cyclopentene or 2-norbornene; non-conjugated diene monomers such as 1,5-hexadiene, 1,6-heptadiene, 1,7-octadiene, dicyclo-pentadiene, or 5-ethylidene-2-norbornene; (meth)acrylic esters such as methyl(meth)acrylate and ethyl(meth)acrylate; and other (meth)acrylic acid derivatives such as (meth)acrylonitrile or (meth)acrylamide.

These monomers can be used singly or in combination of two or more kinds thereof.

Concrete examples of the conjugated diene polymer include a natural rubber (NR), a styrene/butadiene rubber (SBR), a styrene/isoprene rubber (SIR), a polyisoprene rubber (IR), a polybutadiene rubber (BR), an isoprene/isobutylene copolymer rubber (IIR), an ethylene/propylene/diene copolymer rubber (EPDM), a butadiene/isoprene copolymer rubber (BIR), and a styrene/isoprene block copolymer. Of these, a polyisoprene rubber and a polybutadiene rubber are preferable, with a polyisoprene rubber being more preferable.

Though the content of the conjugated diene monomer unit in the conjugated diene polymer is properly chosen within the range where the effects of the invention are not hindered, it is usually 40% by mole or more, preferably 60% by mole or more, and more preferably 80% by mole or more. Above all, one comprised of substantially only a conjugated diene monomer unit is especially preferable. When the content of the conjugated diene monomer unit is too low, it may be difficult to obtain a rate of reduction of unsaturated bonds falling within an appropriate range as described later.

A polymerization method of the conjugated diene polymer may follow a usual way and, for example, is carried out by means of solution polymerization or emulsion polymerization by using an appropriate catalyst such as a Ziegler-type polymerization catalyst containing titanium, etc. as a catalyst component, an alkyllithium polymerization catalyst, and a radical polymerization catalyst.

The cyclized product of a conjugated diene polymer used in the invention is obtained by a cyclization reaction of the foregoing conjugated diene polymer in the presence of an acid catalyst.

As the acid catalyst used in the cyclization reaction, known acid catalysts can be used. Concrete examples thereof include sulfuric acid; organic sulfonic acid compounds such as fluoromethanesulfonic acid, difluoromethanesulfonic acid, p-toluenesulfonic acid, xylenesulfonic acid, alkylbenzenesulfonic acids containing an alkyl group having from 2 to 18 carbon atoms, or anhydrides or alkyl esters thereof; and Lewis acids such as boron trifluoride, boron trichloride, tin tetrachloride, titanium tetrachloride; aluminum chloride, diethylaluminum monochloride, ethylammonium chloride, aluminum bromide, antimony pentachloride, tungsten hexachloride, or iron chloride. These acid catalysts may be used singly or in combination of two or more kinds thereof. Of these, organic sulfonic acid compounds are preferable; and p-toluenesulfonic acid and xylenesulfonic acid are more preferable.

The used amount of the acid catalyst is usually from 0.05 to 10 parts by weight, preferably from 0.1 to 5 parts by weight, and more preferably from 0.3 to 2 parts by weight based on 100 parts by weight of the conjugated diene polymer.

The cyclization reaction is usually carried out in a hydrocarbon solution of the conjugated diene polymer.

The hydrocarbon solvent is not particularly limited so far as it does not hinder the cyclization reaction. Examples thereof include aromatic hydrocarbons such as benzene, toluene, xylene, or ethylbenzene; aliphatic hydrocarbons such as n-pentane, n-hexane, n-heptane, or n-octane; and alicyclic hydrocarbons such as cyclopentane or cyclohexane. A boiling point of such a hydrocarbon solvent is preferably 70° C. or higher.

The solvent used in the polymerization reaction of the conjugated diene polymer and the solvent used in the cyclization reaction may be the same kind. In this case, the cyclization reaction can be carried out subsequent to the polymerization reaction by adding the acid catalyst for the cyclization reaction to the polymerization reaction solution in which the polymerization reaction has completed.

The used amount of the hydrocarbon solvent is usually in the range of from 5 to 60% by weight, and preferably from 20 to 40% by weight in terms of a solids content of the conjugated diene polymer.

Though the cyclization reaction can be carried out under any pressure condition of elevated pressure, reduced pressure or atmospheric pressure, it is desirably carried out under atmospheric pressure from the standpoint of simplicity and easiness of operations. When the cyclization reaction is carried out in a dry gas stream, especially in an atmosphere of dry nitrogen or dry argon, it is possible to suppress side reactions to be caused due to the moisture.

Reaction temperature and reaction time in the cyclization reaction are not particularly limited. The reaction temperature is usually from 50 to 150° C., and preferably from 70 to 110° C.; and the reaction time is usually from 0.5 to 10 hours, and preferably from 2 to 5 hours.

After the cyclization reaction, the acid catalyst is deactivated by a usual way; the acid catalyst residue is removed; and the hydrocarbon solvent is then removed. There can be thus obtained a cyclized product of a conjugated diene polymer in a solid state.

The rate of reduction of unsaturated bonds of the cyclized product of a conjugated diene polymer is usually 10% or more, preferably from 40 to 75%, and more preferably from 55 to 70%. The rate of reduction of unsaturated bonds of the cyclized product of a conjugated diene polymer can be adjusted by properly choosing the amount of the acid catalyst, the reaction temperature, the reaction time and the like in the cyclization reaction.

When the rate of reduction of unsaturated bonds of the cyclized product of a conjugated diene polymer is too low, a glass transition temperature becomes low, and adhesive strength is reduced. Conversely, a cyclized product of a conjugated diene polymer having an excessively high rate of reduction of unsaturated bonds is difficult to manufacture, and only a brittle product is obtainable.

The rate of reduction of unsaturated bonds is an index to express a degree of reduction of unsaturated bonds due to the cyclization reaction in a conjugated diene monomer unit segment in the conjugated diene polymer, and is a numerical value determined in the following manner. In the conjugated diene monomer unit segment in the conjugated diene polymer, a ratio of a peak area of protons bonded directly to the double bond relative to a peak area of all protons is determined before and after the cyclization reaction, respectively, by means of proton NMR analysis, and a rate of reduction thereof is calculated.

In the conjugated diene monomer unit segment in the conjugated diene polymer, a peak area of all protons and a peak area of protons bonded directly to the double bond before the cyclization reaction are defined as SBT and SBU, respectively; and a peak area of all protons and a peak area of protons bonded directly to the double bond after the cyclization reaction are defined as SAT and SAU, respectively. A peak area ratio (SB) of protons bonded directly to the double bond before the cyclization reaction is represented by the formula: SB=SBU/SBT; and a peak area ratio (SA) of protons bonded directly to the double bond after the cyclization reaction is represented by the formula: SA=SAU/SAT.

Accordingly, the rate of reduction of unsaturated bonds is determined by the following expression.

[Rate of reduction of unsaturated bonds (%)]=100×(SB−SA)/SB

A weight-average molecular weight of the cyclized product of a conjugated diene polymer is usually from 1,000 to 1,000,000, preferably from 10,000 to 700,000, and more preferably from 30,000 to 500,000 in terms of standard polystyrene as measured by gel permeation chromatography. The weight-average molecular weight of the cyclized product of a conjugated diene polymer can be adjusted by properly choosing a weight-average molecular weight of the conjugated diene polymer to be provided for the cyclization.

When the weight-average molecular weight of the cyclized product of a conjugated diene polymer is too low, there may be risks that the cyclized product is hard to mold into a film and that mechanical strength is reduced. When the weight-average molecular weight of the cyclized product of a conjugated diene polymer is too high, there may be a possibility that not only solution viscosity increases during the cyclization reaction thereby making it difficult to handle the solution but also workability on extrusion molding is reduced.

The amount of a gel (toluene-insoluble matter) of the cyclized product of a conjugated diene polymer is usually not more than 10% by weight, preferably not more than 5% by weight, and it is especially preferable that the cyclized product of a conjugated diene polymer contains substantially no gel. When the amount of the gel is high, there may be a possibility that smoothness of the film is reduced.

As the existence of an antioxidant in the cyclized product of a conjugated diene polymer hinders oxygen-absorbability of the cyclized product of a conjugated diene polymer in the invention, it is desirable that the cyclized product of a conjugated diene polymer substantially contains no antioxidant. However, in order to guarantee stability at the time of processing the cyclized product of a conjugated diene polymer and for the purpose of controlling oxygen-absorbability, the antioxidant can be added in an amount in the range of not more than 2,000 ppm, preferably from 10 ppm to 700 ppm, and more preferably from 50 ppm to 600 ppm.

The antioxidant is not particularly limited so far as it is one usually used in the field of a resin material or a rubber material. Representative examples of such an antioxidant include hindered phenolic, phosphorus-containing and lactone-based antioxidants. These antioxidants can also be used in combination of two or more kinds thereof.

Concrete examples of the hindered phenolic antioxidant include 2,6-di-t-butyl-p-cresol, pentaerythritol tetrakis[3-(3,5-di-t-butyl-4-hydroxyphenyl)propionate], thiodiethylenebis[3-(3,5-di-t-butyl-4-hydroxyphenyl)propionate], octadecyl-3-(3,5-di-t-butyl-4-hydroxyphenyl)propionate, N,N′-hexan-1,6-diyl bis[3-(3,5-di-t-butyl-4-hydroxyphenyl)propionamide], diethyl[[3,5-bis(1,1-dimethylethyl)-4-hydroxyphenyl]methyl]phosphonate, 3,3′,3″, 5,5′,5″-hexa-t-butyl-a,a′,a″-(mesitylene-2,4,6-triyl)tri-p-cresol, hexamethylene bis-[3-(3,5-di-t-butyl-4-hydroxyphenyl)propionate, tetrakis[methylene-3-(3,5-di-t-butyl-4-hydroxyphenyl)propionate]methane, n-octadecyl-3-(4′-hydroxy-3,5′-di-t-butylphenyl)propionate, 1,3,5-tris(3,5-di-t-butyl-4-hydroxybenzyl)-1,3,5-triazine-2,4,6(1H,3H,5H)-trione, 2,4-bis-(n-octylthio)-6-(4-hydroxy-3,5-di-t-butylanilino)-1,3,5-triazine, tris-(3,5-di-t-butyl-4-hydroxybenzyl)-isocyanurate, 2-t-butyl-6-(3′-t-butyl-2′-hydroxy-5′-methylbenzyl)-4-methylphenyl acrylate, and 2-[1-(2-hydroxy-3,5-di-t-phenylbutyl)ethyl]-4,6-di-t-pentylphenyl acrylate.

Examples of the phosphorus-containing antioxidant include tris(2,4-di-t-butylphenyl)phosphite, bis[2,4-bis(1,1-dimethylethyl)-6-methylphenyl]ethyl phosphite, tetrakis(2,4-di-t-butylphenyl)[1,1-biphenyl]-4,4′-diyl bisphosphonite, and bis(2,4-di-t-butylphenyl)pentaerythritol phosphite.

Also, a lactone-based antioxidant which is a reaction product between 5,7-di-t-butyl-3-(3,4-dimethylphenyl)-3H-benzofuran-2-one, etc. and o-xylene may be used in combination.

Besides, various compounds usually added may be blended in the cyclized product of a conjugated diene polymer, if desired. Examples of such a compound include compounds usually used in an adhesive, inclusive of a filler such as calcium carbonate, alumina, or titanium oxide; a tackifier (for example, hydrogenated petroleum resins, hydrogenated terpene resins, castor oil derivatives, sorbitan higher fatty acid esters, or low-molecular weight polybutene); a plasticizer (for example, phthalic acid esters or glycol esters); a surfactant; a leveling agent; an ultraviolet ray absorbent; a light stabilizer; a dehydrating agent, a pot life extender (for example, acetylacetone, methanol, or methyl orthoacetate); and a cissing improving agent.

In the oxygen-absorbing multilayer film of the invention, the sealing material layer is a layer that has a function to be molten by heat and mutually bonded (heat-sealed) thereby forming a space in the packaging container isolated from the outside of a packaging container and that permits oxygen to permeate to be absorbed in the oxygen-absorbent layer while preventing the direct contact between the oxygen-absorbent layer and a material to be packaged on the inside of the packaging container.

Concrete examples of the heat-sealable resin used for forming the sealing material layer include homopolymers of an α-olefin such as ethylene or propylene, for example, low-density polyethylene, medium-density polyethylene, high-density polyethylene, linear low-density polyethylene, metallocene polyethylene, polypropylene, polymethylpentene, and polybutene; copolymers of ethylene with an α-olefin, for example, an ethylene-propylene copolymer; copolymers of an α-olefin, mainly composed of the α-olefin, with vinyl acetate, an acrylic ester, a methacrylic ester or the like, for example, an ethylene/vinyl acetate copolymer, an ethylene/ethyl acrylate copolymer, an ethylene/methyl methacrylate copolymer, an ethylene-acrylic acid copolymer, and an ethylene/methacrylic acid copolymer; acid-modified polyolefin resins obtained by modifying a polyolefin resin such as polyethylene or polypropylene with an unsaturated carboxylic acid such as acrylic acid, methacrylic acid, maleic acid, maleic anhydride, fumaric acid, or itaconic acid; ionomer resins obtained by making an Na ion or a Zn ion act on a copolymer of ethylene with methacrylic acid; mixtures thereof; and the like.

To the heat-sealable resin, there can be added, if desired, an antioxidant; a tackifier (for example, hydrogenated petroleum resins, hydrogenated terpene resins, castor oil derivatives, sorbitan higher fatty acid esters, and low-molecular weight polybutene); an antistatic agent; a filler; a plasticizer (for example, phthalic acid esters and glycol esters); a surfactant; a leveling agent; a heat resistant stabilizer; a weather resistant stabilizer; an ultraviolet ray absorbent; a light stabilizer; a dehydrating agent, a pot life extender (for example, acetylacetone, methanol, and methyl orthoacetate); a cissing improving agent; an anti-blocking agent; an anti-fogging agent; a lubricant; a reinforcing agent; a flame retardant; a coupling agent; a blowing agent; a mold releasing agent; a coloring agent; a pigment; or the like.

Examples of the antioxidant include antioxidants of the same kind that can be added in the cyclized product of a conjugated diene polymer.

Examples of the anti-blocking agent include silica, calcium carbonate, talc, zeolite, and starch. The anti-blocking agent may be kneaded into the resin or may be attached onto a surface of the resin.

Examples of the anti-fogging agent include higher fatty acid glycerides such as diglycerin monolaurate, diglycerin monopalmitate, diglycerin monooleate, diglycerin dilaurate, or triglycerin monooleate; polyethylene glycol higher fatty acid esters such as polyethylene glycol oleate, polyethylene glycol laurate, polyethylene glycol palmitate, or polyethylene glycol stearate; and polyoxyethylene higher fatty acid alkyl ethers such as polyoxyethylene lauryl ether or polyoxyethylene oleyl ether.

Examples of the lubricant include higher fatty acid amides such as stearic acid amide, oleic acid amide, erucic acid amide, behenic acid amide, ethylene bisstearic acid amide, or ethylene bisoleic acid amide; higher fatty acid esters; and waxes.

Examples of the antistatic agent include glycerin esters, sorbitan acid esters, and polyethylene glycol esters of a higher fatty acid.

Examples of the reinforcing agent include metallic fibers, glass fibers, and carbon fibers.

Examples of the flame retardant include phosphoric esters, halogenated phosphoric esters, and halides.

Examples of the coupling agent include silane-based, titanate-based, chromium-based and aluminum-based coupling agents.

Examples of the coloring agent or the pigment include various azo pigments such as a phthalocyanine-based, an indigo-based, a quinacridone-based, or a metallic complex salt-based azo pigment; a basic or acidic water-soluble dye; oil-soluble dyes such as an azo-based, an anthraquinone-based, or a perylene-based oil-soluble dye; metal oxides such as a titanium oxide-based, an iron oxide-based, or a complex oxide-based metal oxide; and other inorganic pigments such as a chromate-based, a sulfide-based, a silicate-based, or a carbonate-based inorganic pigment.

Examples of the blowing agent include methylene chloride, butane, and azobisisobutyronitrile.

Examples of the mold-releasing agent include polyethylene waxes, silicone oils, long-chain carboxylic acids, and long-chain carboxylic acid metal salts.

The oxygen permeability at 25° C. of the sealing material layer of the invention is preferably 200 cc/m²·atm·day Or more irrespective of the number, thickness and constitutional materials of the layer, and especially preferably 400 cc/m²·atm·day or more. When the oxygen permeability of the sealing material layer is lower than 200 cc/m²·atm·day, there is a risk that it acts as the rate-determining step of the oxygen absorption to be carried out in the oxygen-absorbing layer thereby reducing the oxygen absorption rate of the packaging container.

The permeability is expressed by a volume of a gas passing through a specimen of a unit area for a unit time with a unit partial pressure difference and can be measured by a method prescribed in JIS K7126, “Test method for gas permeation rate of plastic films and sheets”.

Though the oxygen-absorbing multilayer film of the invention comprises basically a gas barrier material layer, an oxygen-absorbent layer and a sealing material layer laminated in this order, an adhesive layer or a supporting substrate layer may be provided between the respective layers, if desired, in addition to the foregoing external protective layer.

A film or sheet of a resin capable of being molten by heat and mutually fused can be used for the adhesive layer. Concrete examples of such a resin include polyurethane; homopolymers or copolymers of an α-olefin such as low-density polyethylene, linear low-density polyethylene, medium-density polyethylene, high-density polyethylene or polypropylene; an ethylene/vinyl acetate copolymer, an ethylene-acrylic acid copolymer, an ethylene/ethyl acrylate copolymer, an ethylene/methacrylic acid copolymer or an ethylene/methyl methacrylate copolymer; acid-modified poly-α-olefin resins obtained by modifying an α-olefin (co)polymer such as polyethylene or polypropylene with an unsaturated carboxylic acid such as acrylic acid, methacrylic acid, maleic acid or maleic anhydride; ionomer resins obtained by making an Na ion or a Zn ion act on a copolymer of ethylene with methacrylic acid, or the like; and mixtures thereof.

As a material used for constituting the supporting substrate layer, are employed poly-α-olefin resins; polyester resins such as polyethylene terephthalate (PET); polyamide resins such as polyamide 6 or a polyamide 6-polyamide 66 copolymer; natural fibers; or synthetic fibers.

The supporting substrate layer may be provided between the oxygen-absorbent layer and the gas barrier material layer or may be provided in the order of oxygen-absorbent layer/gas barrier material layer/supporting substrate layer.

The whole thickness of the multilayer film of the invention is less than 250 μm, and preferably from 50 to 150 μm. By making the whole thickness fall within the foregoing range, a multilayer film with excellent transparency can be prepared.

The thickness of the oxygen-absorbent layer is usually approximately from 1 to 50 μm, and preferably approximately from 5 to 30 μm.

The thickness of the gas barrier material layer is usually approximately from 5 to 50 μm, and preferably approximately from 10 to 50 μm.

The thickness of the sealing material layer is usually approximately from 10 to 150 μm, and preferably approximately from 20 to 100 μm.

Too thin a thickness of respective layers may cause uneven thickness or insufficient rigidity or mechanical strength. Also, in the case of a heat-sealable resin, too thick or too thin a thickness may prohibit heat-sealable properties to be exhibited.

The manufacturing method of the oxygen-absorbing multilayer film of the invention is not particularly limited. Single-layer films of the respective layers constituting the multilayer film may be laminated, or a multilayer film may be molded directly.

The single-layer film can be manufactured by a known method. For example, the film can be obtained by a solution casting method in which a resin composition or the like constituting each layer is dissolved in a solvent, and the thus-obtained solution is applied on a practically flat surface and dried. Alternatively, for example, a T-die method film, a blown film, or the like is obtained by melting and kneading a resin composition or the like constituting each layer by an extruder and then extruding the mixture into a predetermined shape by passing through a T-die, a circular die (ring die), etc. As the extruder, kneaders such as a single screw-extruder, a twin-screw extruder, or a Banbury mixer can be used. The T-die film can be formed into a biaxially stretched film by biaxial stretch.

The multilayer film can be manufactured from the thus-obtained single-layer films by an extrusion coating method, sandwich lamination, or dry lamination.

For the manufacture of a multilayer extrusion film, a known co-extrusion molding method can be employed. For example, extrusion molding may be carried out in the same manner as described above, except for using extruders in the number corresponding to the kinds of resins and using a multilayer multiple die.

Examples of the co-extrusion molding method include a co-extrusion lamination method, a co-extrusion sheet molding method, and a co-extrusion inflation molding method.

A tubular raw film can be formed, for example, by melting and heating each of resins constituting a gas barrier material layer, an oxygen-absorbent layer and a sealing material layer, respectively by several extruders; extruding them from a multilayer ring die at an extrusion temperature of, for example, from 190 to 210° C.; and immediately thereafter, quenching for solidification the extrudate by a liquid coolant such as cooling water by means of a water-cooling or air-cooling inflation method.

On manufacturing the multilayer film, the temperature of each of the resin for the gas barrier material layer, the cyclized product of a conjugated diene polymer and the resin for the sealing material layer is preferably set up at from 160 to 250° C. When the temperature is lower than 160° C., uneven thickness or film breakage occurs, whereas when the temperature exceeds 250° C., film breakage may possibly be caused. The temperature is more preferably from 170 to 230° C.

A film take-up rate in the manufacture of the multilayer film is usually from 2 to 200 m/min, and preferably from 50 to 100 m/min. When the take-up rate is too low, the production efficiency is liable to get worse, whereas when the take-up rate is too fast, the film cannot be sufficiently cooled, whereby fusion may possibly occur at taking-up.

In the case where the gas barrier material layer film is made of a stretchable material such as polyamide resins, polyester resins, polypropylene, or the like, and film properties thereof are enhanced by stretching, the multilayer film obtained by co-extrusion can be further uniaxially or biaxially stretched. If required, heat setting can be further applied.

Though a stretch ratio is not particularly limited, it is usually from 1 to 5 times in a machine direction (MD) and a transverse direction (TD), respectively, and preferably from 2.5 to 4.5 times in the MD and TD, respectively.

The stretching can be carried out by a known method such as a tenter stretching method, an inflation stretching method, or a roll stretching method. With respect to the order of stretching, though either of the machine direction or the transverse direction may be earlier, simultaneous stretching is preferable. A tubular simultaneous biaxial stretching method may also be employed.

The gas barrier material layer film can be subjected to front surface printing or rear surface printing or the like with a desired printing pattern, for example, letters, figures, symbols, designs, and patterns by a usual printing method.

The shape of the oxygen-absorbing multilayer film of the invention is not particularly limited and may be any one of a flat film, an embossed film, and the like.

The oxygen-absorbing multilayer film of the invention is useful as a packaging material.

The packaging material composed of the oxygen-absorbing multilayer film of the invention can be molded into a packaging container of every shape and used.

Examples of a form of the packaging container obtained from the packaging material of the invention include a casing, a bag-like material, or the like. Examples of a form of the packaging material obtained from the multilayer film of the invention include usual three-side-sealed or four-side-sealed pouches, gusset-provided pouches, standing pouches, and pillow packaging bags. In the case where the oxygen-absorbing multilayer film is a flat film, it can be formed into a packaging material having a desired form by molding by a usual method; and in the case where the oxygen-absorbing multilayer film is a tubular raw material, it can be formed into a casing or a bag-like material as it is.

The packaging material of the invention can be formed into a stretched molded article by re-heating at a temperature of not higher than a melting point of the constituent resins and uniaxially or biaxially stretching by a thermoforming method such as drawing, a roll stretching method, a pantograph type stretching method, an inflation stretching method, or the like.

The packaging container obtained from the packaging material composed of the oxygen-absorbing multilayer sheet of the invention is effective for preventing deterioration of the contents due to oxygen to prolong a shelf life. Examples of the contents which can be filled include foodstuffs such as rice cakes, Chinese noodles, fruits, nuts, vegetables, meat products, infant foods, coffee, cooking oils, sauces, foods boiled down in soy, dairy products, and Japanese and Western confectioneries; drugs; cosmetics; chemicals such as bonding agents and adhesives; miscellaneous goods such as chemical pocket warmers; and the like.

### EXAMPLES

The invention is more specifically described below with reference to the following Preparation Examples and Examples. Parts and percentages in each of the Examples are on a mass basis unless otherwise indicated.

Respective properties were evaluated in the following methods.

### [Weight-Average Molecular Weight (Mw) of a Cyclized Product of a Conjugated Diene Polymer]

This is determined as a molecular weight in terms of polystyrene by gel permeation chromatography.

### [Rate of Reduction of Unsaturated Bonds of a Cyclized Product of a Conjugated Diene Polymer]

This is determined by means of proton NMR analysis while referring to methods described in the following documents (i) and (ii).
(i) M. A. Golub and J. Heller, Can. J. Chem., Vol. 41. pp 937 (1963)
(ii) Y. Tanaka and H. Sato, J. Polym. Sci.: Poly. Chem. Ed., Vol. 17, p. 3027 (1979)

In the conjugated diene monomer unit segment in the conjugated diene polymer, a peak area of all protons and a peak area of protons bonded directly to the double bond before the cyclization reaction are defined as SBT and SBU, respectively; and a peak area of all protons and a peak area of protons bonded directly to the double bond after the cyclization reaction are defined as SAT and SAU, respectively. A peak area ratio (SB) of protons bonded directly to the double bond before the cyclization reaction is represented by the formula: SB=SBU/SBT; and a peak area ratio (SA) of protons bonded directly to the double bond after the cyclization reaction is represented by the formula: SA=SAU/SAT.

Accordingly, the rate of reduction of unsaturated bonds is determined by the following expression.

[Rate of reduction of unsaturated bonds (%)]=100×(SB−SA)/SB

### [Oxygen Concentration]

This is measured by using an oxygen concentration meter (a trade name: FOOD CHECKER HS-750, manufactured by Ceramatec, Inc., U.S.A.).

[Odor in Packaging Container after Oxygen Absorption]

An oxygen-absorbing multilayer film is heat-sealed at two places with the sealing material layers inside thereof to provide a bag of 400 mm×200 mm. Air in an amount of 200 milliliters is charged in this bag, and the bag is tightly closed by heat-seal. This bag is allowed to stand in an atmosphere at 40° C. for 7 days and then opened. Five panelists evaluate odors.

### Preparation Example 1

### Preparation of a Cyclized Product A of a Conjugated Diene Polymer

A pressure-resistant reactor equipped with a stirrer, a thermometer, a reflux condenser and a nitrogen gas introduction pipe was charged with 300 parts of polyisoprene (cis-1,4-structural unit: 73%, trans-1,4-structural unit: 22%, 3,4-structural unit: 5%, weight-average molecular weight: 174,000) as cut into a size of 10 mm in square along with 700 parts of cyclohexane, and the inside of the reactor was purged with nitrogen. The contents were heated at 85° C.; the polyisoprene was completely dissolved in cyclohexane under stirring; 2.4 parts of p-toluenesulfonic acid having a water content of not more than 150 ppm in a 15% toluene solution was then added; and a cyclization reaction was carried out at 75° C. After the reaction was continued for 4 hours, 3.7 parts of a 25% sodium carbonate aqueous solution was added to stop the reaction. Washing with 2,000 parts of ion-exchanged water at 75° C. was repeated three times thereby to remove the catalyst residue in the system.

After an antioxidant, tetrakis[methylene-3-(3,5-di-t-butyl-4-hydroxyphenyl)propionate]methane in an amount corresponding to 300 ppm relative to the cyclized polyisoprene was added to the obtained cyclized polyisoprene solution, cyclohexane in the solution was partially distilled off, and the residue was further dried in vacuo to remove cyclohexane and toluene to give a cyclized product A of the conjugated diene polymer in a solid state. The rate of reduction of unsaturated bonds and the weight-average molecular weight of the cyclized product A of the conjugated diene polymer were measured. The results are shown in Table 1.

### Preparation Example 2

### Preparation of a Cyclized Product B of a Conjugated Diene Polymer

A cyclized product B of a conjugated diene polymer was obtained in the same manner as in Preparation Example 1, except that xylenesulfonic acid in an amount of 2.25 parts was used instead of p-toluenesulfonic acid, that the amount of the 25% sodium carbonate aqueous solution to be added after the cyclization reaction was changed to 3.20 parts and that the antioxidant was changed to 2-t-butyl-6-(3′-t-butyl-2′-hydroxy-5′-methylbenzyl)-4-methylphenyl acrylate in an amount corresponding to 300 ppm relative to the cyclizedpolyisoprene. The evaluation results of the cyclized product B of a conjugated diene polymer are shown in Table 1.

TABLE 1

| | Preparation | Preparation |
|---|---|---|
| | Example 1 | Example 2 |
| Cyclized product of a conjugated diene | A | B |
| polymer | | |
| Weight-average molecular weight | 130,500 | 139,800 |
| Rate of reduction of unsaturated bonds (%) | 64 | 56 |

### Example 1

A 20% cyclohexane solution of the cyclized product A of a conjugated diene polymer was applied on a non-stretched polypropylene film having a thickness of 25 μm (a trade name: PYLEN P1128, manufactured by Toyobo Co., Ltd.) by using a wire bar and dried to form a cast film having a thickness of 20 μm. The obtained cast film and a barrier film having a configuration of polyethylene terephthalate (thickness: 12 μm)/adhesive/aluminum (thickness: 15 μm) (available from Showa Denko Packaging Co., Ltd.) were laminated and bonded so as to have an order of non-stretched polypropylene film (sealing material layer)/cyclized product A of a conjugated diene polymer (oxygen-absorbent layer)/aluminum layer/polyethylene terephthalate layer (gas barrier material layer) by using a hot roll laminator (a trade name: EXCELAM II 355Q, manufactured by Gmp Co., Ltd.) as set up at 140° C. to give an oxygen-absorbing multilayer film. The multilayer film was heat-sealed at two places so as to form a bag having a size of 400 mm×200 mm and was tightly closed by heat seal together with 200 milliliters of air. This was allowed to stand at 40° C. for 7 days, and an oxygen concentration in the bag was then measured by using an oxygen concentration meter. The presence or absence of odors in the bag, after oxygen absorption of the film, was judged. These results are shown in Table 2.

### Example 2

The cyclized product B of a conjugated diene polymer in place of the cyclized product A of a conjugated diene polymer and a barrier film obtained by a surface treatment of one surface of an ethylene/vinyl alcohol copolymer film (thickness: 12 μm, a trade name: EVAL EF-XL film, available from Kuraray Trading Co., Ltd.) with maleic anhydride-modified polypropylene were laminated and bonded so as to have an order of (non-stretched polypropylene film)/(cyclized product B of a conjugated diene polymer)/(maleic anhydride-modified polypropylene surface treated layer)/(ethylene/vinyl alcohol copolymer film) to give an oxygen-absorbing multilayer film. By using this multilayer film, an oxygen concentration in the bag was measured, and the presence or absence of odors was judged in the same manner as in Example 1. These results are shown in Table 2.

### Example 3

A 20% toluene solution of the cyclized product A of a conjugated diene polymer was prepared without being brought into contact with oxygen. To this solution, cobalt neodecanoate in such an amount that the amount of cobalt metal contained therein was 500 ppm relative to the cyclized product A of a conjugated diene polymer was added. After partially distilling off toluene from this solution followed by drying in vacuo to remove toluene, a cobalt neodecanoate-blended cyclized product C of a conjugated diene polymer was obtained.

An oxygen concentration in the bag was measured, and the presence or absence of odors was judged in the same manner as in Example 1, except that the cyclized product C of a conjugated diene polymer was used in place of the cyclized product A of a conjugated diene polymer. These results are shown in Table 2.

### Comparative Example 1

A 20% cyclohexane solution of polyisoprene D (cis-1,4-structural unit: 73%, trans-1,4-structural unit: 22%, 3,4-structural unit: 5%, weight-average molecular weight: 174,000) was prepared without being brought into contact with oxygen, applied on a non-stretched polypropylene film (a trade name: PYLEN P1128, manufactured by Toyobo Co., Ltd.) having a thickness of 25 μm by using a wire bar, and dried to form a cast film having a thickness of 20 μm. The obtained cast film was laminated with and bonded to a barrier film in the same manner as in Example 1, followed by lamination and bonding so as to have an order of non-stretched polypropylene (sealing material layer)/polyisoprene D (corresponding to an oxygen-absorbent layer)/barrier film (gas barrier material layer) to give a multilayer film. The multilayer film is heat-sealed at two places so as to form a bag having a size of 400 mm×200 mm and was tightly closed by heat seal together with 200 milliliters of air. This was allowed to stand at 40° C. for 7 days, and an oxygen concentration in the bag was then measured by using an oxygen concentration meter. The presence or absence of odors in the bag was judged. These results are shown in Table 2.

### Comparative Example 2

A 20% toluene solution of polyisoprene D (cis-1,4-structural unit: 73%, trans-1,4-unit: 22%, 3,4-unit: 5%, weight-average molecular weight: 174,000) was prepared without being brought into contact with oxygen. To this solution, cobalt neodecanoate in such an amount that the amount of cobalt metal contained therein was 500 ppm relative to the polyisoprene D was added. After partially distilling off toluene from this solution followed by drying in vacuo to remove toluene, a cobalt neodecanoate-blended polyisoprene E was obtained.

An oxygen concentration in the bag was measured, and the presence or absence of odors was judged in the same manner as in Example 1, except that the polyisoprene E was used in place of the cyclized product A of a conjugated diene polymer. These results are shown in Table 2.

TABLE 2

| | | | | Compar- | Compar- |
|---|---|---|---|---|---|
| | | | | ative | ative |
| | Example | Example | Example | Example | Example |
| | 1 | 2 | 3 | 1 | 2 |
| Polymer | Cyclized | Cyclized | Cyclized | Polyiso- | Polyiso- |
| | product A | product B | product C | prene | prene |
| | of a | of a | of a | D | E |
| | conjugated | conjugated | conjugated | | |
| | diene | diene | diene | | |
| | polymer | polymer | polymer | | |
| Presence or | No | No | Yes | No | Yes |
| absence of | | | | | |
| cobalt salt | | | | | |
| Oxygen | 0.5 | 1.1 | 0.5 | 20.8 | 8.5 |
| concen- | | | | | |
| tration | | | | | |
| (%) | | | | | |
| Odor after | Faint odor | Faint odor | Slight acid | Acid | Acid |
| oxygen | | | odor | odor | odor |
| absorption | | | | | |

As shown in Table 2, in the multilayer film having a structure of non-stretched polypropylene/polyisoprene D/(polyethylene terephthalate/aluminum) barrier film, the oxygen concentration in the bag was little reduced, and acid odors were detected (see Comparative Example 1). When the cobalt salt-containing polyisoprene E was used, though the oxygen concentration in the bag was reduced to some extent, acid odors were similarly detected (see Comparative Example 2).

On the other hand, in the case of the oxygen-absorbing multilayer film having a non-stretched polypropylene (sealing material layer)/cyclized product A of a conjugated diene polymer or cyclized product B of a conjugated diene polymer (oxygen-absorbent layer)/barrier film (gas barrier material layer) structure according to the invention, remarkable oxygen absorption was observed with a largely reduced oxygen concentration in the bag, and residual odors such as acid odors were detected to a very slight extent (see Examples 1 and 2). When the cobalt salt was contained, though the oxygen concentration was reduced to the same degree as in the case of a cobalt salt-free cyclized product of a conjugated diene polymer, acid odors were detected a little (see Example 3).

From these results, it is noted that the oxygen-absorbing multilayer film of the invention is excellent in oxygen-absorbability even in the absence of a transition metal salt, and in particular, in the case of using no transition metal salt, a residual odor such as acid odors after oxygen absorption is detected to a very slight extent.

1. A method for absorbing oxygen comprising exposing an oxygen-absorbing multilayer film having a thickness of less than 250 μm that comprises a gas barrier material layer, an oxygen-absorbent layer and a sealing material layer laminated in this order, wherein an oxygen-absorbent constituting the subject oxygen-absorbent layer comprises a cyclized product of a conjugated diene polymer as the major component.

2. The method according to claim 1, wherein the oxygen-absorbent layer comprises 60% by weight or more of a cyclized product of a conjugated diene polymer relative to the whole constitutional components of the oxygen-absorbent layer.

3. The method according to claim 1, wherein the cyclized product of a conjugated diene polymer contains 0-2,000 ppm of an antioxidant.

4. The method according to claim 1, wherein the cyclized product of a conjugated diene polymer has a rate of reduction of unsaturated bonds of 10% or more.

5. The method according to claim 1, wherein the conjugated diene polymer contains 40% by mole or more of a conjugated diene monomer unit.

6. The method according to claim 1, wherein the conjugated diene polymer is a polyisoprene rubber or a polybutadiene rubber.

7. A method for preventing deterioration of contents in a container comprising sealing the contents in a packaging container obtained by molding a packaging material comprising an oxygen-absorbing multilayer film having a thickness of less than 250 μm that comprises a gas barrier material layer, an oxygen-absorbent layer and a sealing material layer laminated in this order, wherein an oxygen-absorbent constituting the subject oxygen-absorbent layer comprises a cyclized product of a conjugated diene polymer as the major component.

8. The method according to claim 7, wherein the oxygen-absorbent layer comprises 60% by weight or more of a cyclized product of a conjugated diene polymer relative to the whole constitutional components of the oxygen-absorbent layer.

9. The method according to claim 7, wherein the cyclized product of a conjugated diene polymer contains 0-2,000 ppm of an antioxidant.

10. The method according to claim 7, wherein the cyclized product of a conjugated diene polymer has a rate of reduction of unsaturated bonds of 10% or more.

11. The method according to claim 7, wherein the conjugated diene polymer contains 40% by mole or more of a conjugated diene monomer unit.

12. The method according to claim 7, wherein the conjugated diene polymer is a polyisoprene rubber or a polybutadiene rubber.
